(19) United States
(12) Patent Application Publication
(10) Pub. No.: US 2002/0118014 A1
(43) Pub. Date: Aug. 29, 2002

(54) Hall-effect device mounting for brushless motor commutation

(76) Inventors: Daniel A. Crawford, Burton, MI (US); David M. Skrzela, Clio, MI (US)

Correspondence Address: DELPHI TECHNOLOGIES, INC., Legal Staff, P.O. Box 5052, Mail Code: 480-414-420, Troy, MI, 48007-5052, US

(21) Appl. No.: 09/903,944

(22) Filed: Jul. 12, 2001

Related U.S. Application Data
(60) Provisional application No. 60/271,978, filed on Feb. 27, 2001.

(51) Int. Cl. H01F 5/00; G01B 7/14; G01B 7/30

(52) U.S. Cl. 324/207.17; 324/207.25

(57) ABSTRACT

An embodiment of the invention is a printed wiring board mounting structure for use in a brushless motor commutation controller. The printed wiring board includes interconnects for receiving Hall-effect sensors. The interconnects include a first set of interconnects dedicated to a first Hall-effect sensor group having a first plurality of Hall-effect sensors having a first Hall-effect sensor package. The interconnects also include a second set of interconnects dedicated to a second Hall-effect sensor group having a second plurality of Hall-effect sensors having a second Hall-effect sensor package.

### CROSS-REFERENCE TO RELATED APPLICATIONS

This application claims the benefit of U.S. provisional patent application serial number 60/271,978 filed Feb. 27, 2001, the entire contents of which are incorporated herein by reference.

### BACKGROUND

Currently, actuators are used in vehicular applications such as heavy-duty diesel trucks, particularly in turbo-charged and emission control systems. These actuators, referred to as remote smart actuators (RSA's), integrate a microprocessor-based electronic controller into a brushless motor/gear train/output shaft mechanism. The primary function of the RSA is to position an output shaft quickly and accurately as commanded by the vehicle's Engine Control Module (ECM). This action is then translated via linkage to the appropriate system actuator.

The commutation of an RSA's brushless motor is microprocessor controlled, based on Hall-effect rotor position sensors mounted on the electronic controller's printed wiring board (PWB). It is known in the art that resistance modulation of Hall elements or magneto-resistors can be employed in position and speed sensors with respect to moving magnetic materials or objects. A close-proximity rotor sense magnet attached to the rotor shaft which rotates in a plane adjacent to the Hall-effect sensors excites the Hall-effect sensors. As the rotor and sense magnet rotate, the Hall-effect sensors change state accordingly.

FIG. 1 illustrates the layout of three Hall effect sensors 1, 2 and 3 mounted at uniformly spaced intervals on the PWB. Each sensor is mounted proximate to an annular sense magnet having a center 4. Typically, each sensor's region of highest sensitivity is aligned with a peak magnetization circle 5 of the sense magnet. The three sensors 1, 2 and 3 are spaced uniformly at 120 degree intervals along the magnetization circle 5 of the annular sense magnet. The sense magnet is divided into sections of alternating polarity and thus, each sensor 1, 2 and 3 generates an alternating output signal 100. From these output signals, a microprocessor-based controller determines the position of the sense magnet, and thus the rotor.

Hall-effect sensors come in a variety of packages. Historically, as shown in FIG. 2a, a single type of Hall-effect sensor package, shown at 11, 21 and 31, is used. FIG. 2b depicts a printed wiring board (PWB) having circuit interconnects (e.g., pads, plated through-holes, etc.) positioned to accommodate only one particular Hall-effect sensor package. As shown in FIG. 2b, the PWB circuit pattern includes interconnects 111, 121 and 131 corresponding to each Hall-effect sensor package 11, 21 and 31, respectively. Also, FIG. 2a includes associated electronic components (e.g., resistors, capacitors, etc.) 12-14, 22-24, 32-34 used to interface each Hall-effect sensor with a local power supply and a micro-controller. FIG. 2b illustrates the PWB circuit pattern and its corresponding component interconnects 112-114, 122-124, 132-134 for the associated components.

A drawback to the PWB in FIG. 2b is that if an alternate Hall-effect sensor package is to be used (e.g., due to supply chain pressures, customer requests, etc.) a new PWB needs to be developed for the alternate Hall-effect sensor package. This adds expense and increases product development time.

### SUMMARY

An embodiment of the invention is a printed wiring board mounting structure for use in a brushless motor commutation controller. The printed wiring board includes interconnects for receiving Hall-effect sensors. The interconnects include a first set of interconnects dedicated to a first Hall-effect sensor group having a first plurality of Hall-effect sensors having a first Hall-effect sensor package. The interconnects also include a second set of interconnects dedicated to a second Hall-effect sensor group having a second plurality of Hall-effect sensors having a second Hall-effect sensor package.

The above described and other features are exemplified by the following figures and detailed description.

### BRIEF DESCRIPTION OF THE DRAWINGS

Referring now to the Figures, which are meant to be exemplary and not limiting, and wherein like elements are numbered alike in the figures:

FIG. 1 depicts a schematic diagram of a brushless motor commutation system using a single set of Hall-effect sensors;

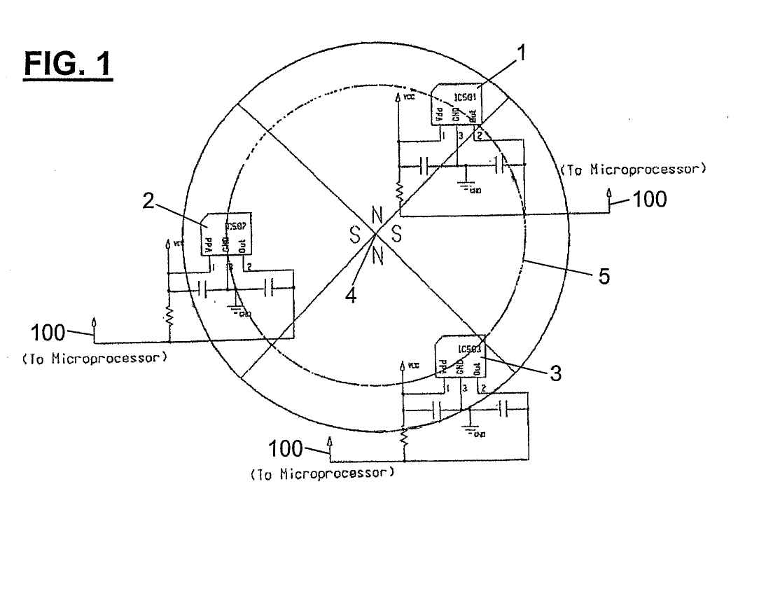

FIG. 2a depicts a mounting configuration for a single set of Hall-effect sensor packages;

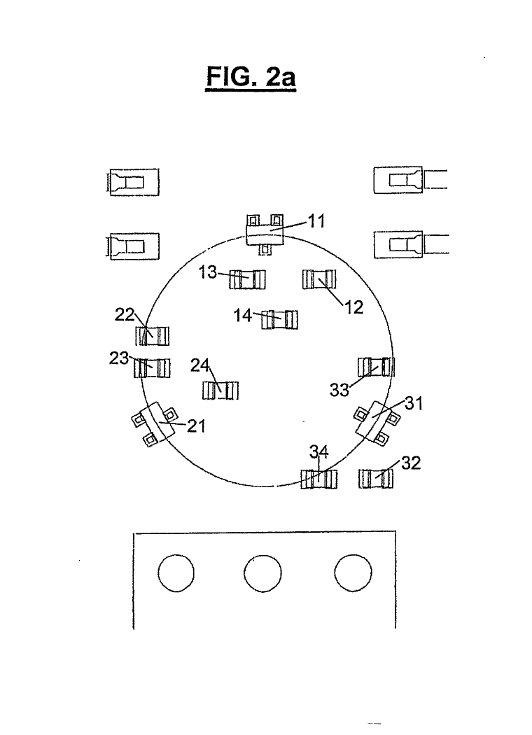

FIG. 2b depicts the circuit pattern for the single set of Hall-effect sensor packages shown in FIG. 2a;

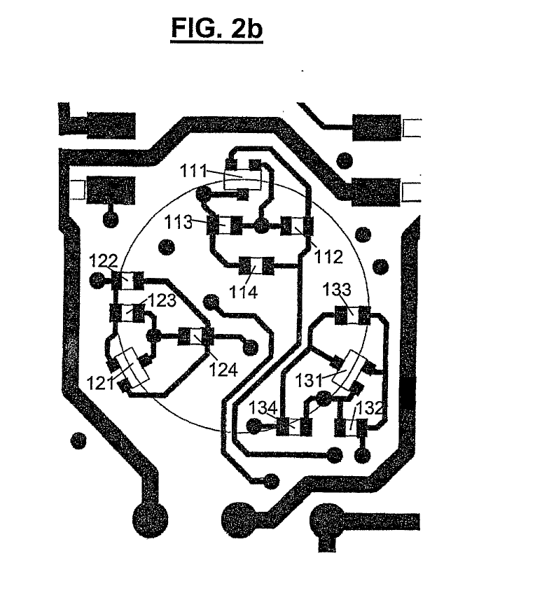

FIG. 3 depicts a schematic diagram of a brushless motor commutation system using more than one type of Hall-effect sensor;

FIG. 4a depicts the mounting configuration for more than one set of Hall-effect sensor packages; and

FIG. 4b depicts the circuit pattern for the sets of Hall-effect sensor packages shown in FIG. 4a .

### DESCRIPTION OF THE PREFERRED EMBODIMENT

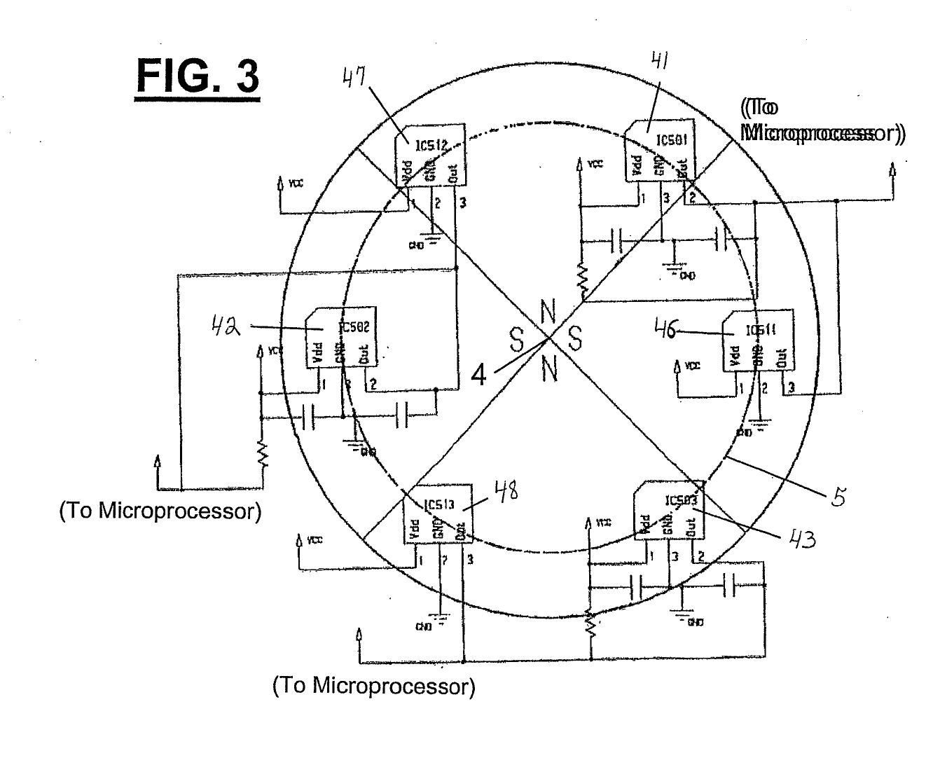

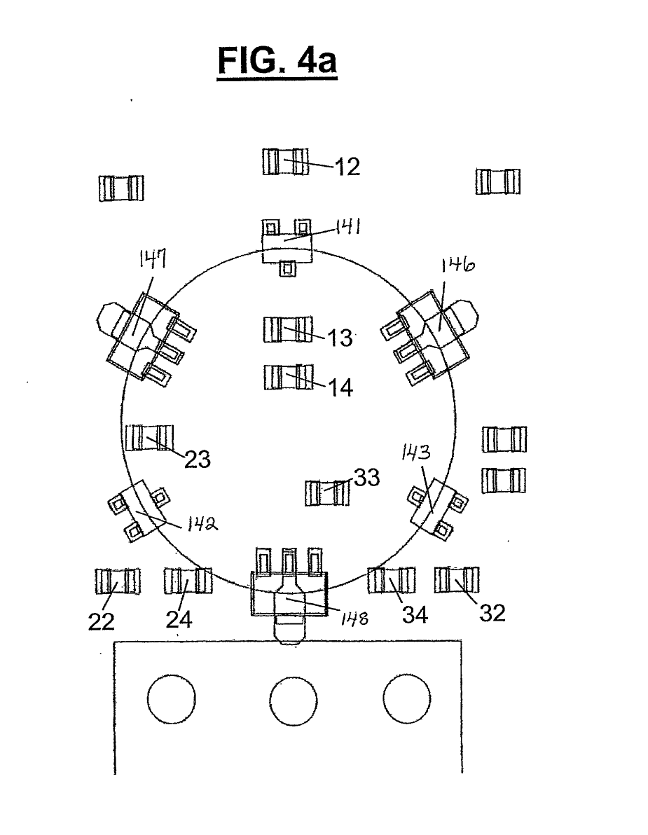

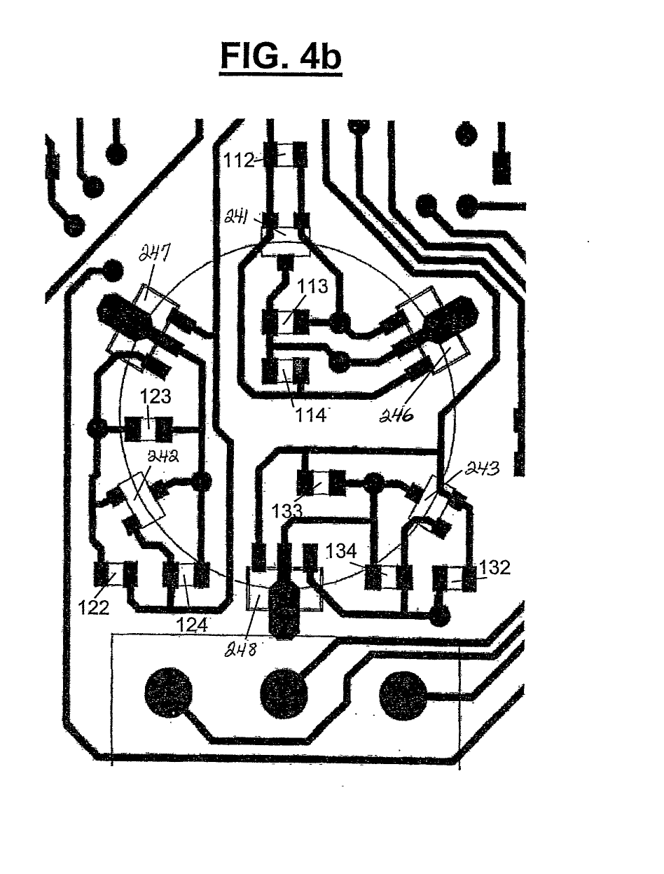

FIGS. 3, 4a and 4b depict an exemplary embodiment of this invention. The PWB includes interconnects to accommodate two different types of Hall-effect sensor packages. As shown in the schematic diagram of FIG. 3, the system may be implemented using a first group of Hall-effect sensors 41, 42 and 43 or a second group of Hall-effect sensors 46, 47 and 48.

As shown in FIG. 4a, the groups of Hall-effect sensors having distinct packages. Hall-effect sensor packages 141, 142 and 143 feature three leads, with two leads on one side of the package and one lead on the other side of the package. Hall-effect sensor packages 146, 147 and 148 feature three leads on one side of the package. The Hall-effect sensor packages may use surface mount legs, solder leads, press-fit leads, ball grid arrays, etc. By using a PWB having multiple interconnect patterns, either group of Hall-effect sensors may be mounted to the PWB.

As shown in FIG. 4b, the PWB includes two groups of interconnects, each designed to specifically fit a different Hall-effect sensor package. Each of group of interconnects accommodates three Hall-effect sensors, spaced uniformly at 120 degree intervals, positioned along magnetization circle 5. In this embodiment, the Hall-effect sensors are spaced uniformly, such that the interconnects for each Hall-effect sensor is 60 degrees apart. As seen in FIGS. 4a and 4b, a first set of PWB interconnects 241, 242 and 243 (for sensors 141, 142 and 143) are different than the second set of PWB interconnects 246, 247 and 248 (for sensors 146, 147 and 148). In FIG. 4b the first set of interconnects and second set of interconnects are arranged in a common circular pattern on magnetization circle 5. It is understood the sets of interconnects may be arranged in other patterns such as in concentric circles. During assembly of the circuit board, only one group of three Hall-effect sensors would be placed on the PWB. The remaining three PWB interconnects would remain unused.

FIG. 4a depicts associated components 12-14, 22-24 and 32-34 used to interface each Hall-effect sensor to a local power supply and micro-controller. These components are typically the same, independent of the Hall-effect sensor package type. In this way each Hall-effect sensor interconnect pattern will share associated components with one adjacent Hall-effect sensor interconnect pattern. This is apparent in FIG. 3 that shows two adjacent sensors (42 and 47) connected to common components. This is also evident in FIG. 4b, which illustrates the PWB interconnects. For example, as shown in FIG. 4b, interconnects 247 and 242 (corresponding to Hall-effect sensor packages 147 and 142) are coupled in parallel with interconnects 122, 123 and 124 (corresponding to components 22, 23 and 24). In this way, either Hall-effect sensor 47 or Hall effect sensor 42 is coupled to components 22, 23 and 24.

The interconnects for the Hall-effect sensors may vary from those shown in FIG. 4b. For example, while each set of interconnects provides 120 degree, uniform spacing between sensors, the spacing between sets of interconnects could be more or less than 60. In addition, the interconnects on the PWB may have a variety of forms including circuit pads, plated through-holes, ball grid arrays, etc.

Operation of the brushless motor commutation is independent of which Hall-effect sensor set is used. The 60 degree staging between adjacent interconnects has a minimal effect on system operation. Differences in the height of Hall-effect sensor packages does not impact system operation, as long as the rotor sense magnet field strength is sufficient at the surface of the Hall-effect sensor package.

While preferred embodiments have been shown and described, various modifications and substitutions may be made thereto without departing from the spirit and scope of the invention.

What is claimed is:

1. A printed wiring board mounting structure for use in a brushless motor commutation controller comprising:
interconnects on said printed wiring board, each of said interconnects receiving a Hall-effect sensor, said interconnects including:
a first set of interconnects dedicated to a first Hall-effect sensor group comprising a first plurality of Hall-effect sensors having a first Hall-effect sensor package, and
a second set of interconnects dedicated to a second Hall-effect sensor group comprising a second plurality of Hall-effect sensors having a second Hall-effect sensor package.

2. The printed wiring board mounting structure of claim 1, wherein the interconnects within each of said first set and said second set are spaced apart equally in a circular pattern.

3. The printed wiring board mounting structure of claim 1, wherein said first set and second set of interconnects are in concentric circular patterns.

4. The printed wiring board mounting structure of claim 1, wherein said first set and second set of interconnects coexist in one circular pattern.

5. The printed wiring board mounting structure of claim 1, wherein within said first set of interconnects, each interconnect is spaced 120 degrees apart.

6. The printed wiring board mounting structure of claim 1, wherein said first set and second set of interconnects alternate along a circular pattern.

7. The printed wiring board mounting structure of claim 6, wherein each interconnect is 60 degrees apart from an adjacent interconnect.

8. The printed wiring board mounting structure of claim 1, consisting of a group of Hall-effect sensors mounted in one of said first set and said second set of interconnects, wherein the other of said first set and said second set of interconnects is vacant.

9. The printed wiring board mounting structure of claim 1, wherein said first Hall-effect sensor package is different than said second Hall-effect sensor package.

10. The printed wiring board mounting structure of claim 1, further comprising:
at least one component interconnect for receiving an electrical component;
wherein an interconnect from said first set of interconnects and an interconnect from said second set of interconnects are connected in parallel with said at least one component interconnect.

11. The printed wiring board mounting structure of claim 1 where said first set of interconnects includes circuit pads.

12. The printed wiring board mounting structure of claim 1 where said first set of interconnects includes plated through-holes.
